(19) United States
(12) Patent Application Publication
(10) Pub. No.: US 2005/0247237 A1
(43) Pub. Date: Nov. 10, 2005

(54) Carbon material

(76) Inventors: Gerd Schukat, Merseburg (DE); Bernd Knackfuss, Leipzig (DE); Egon Fanghanel, Halle (DE); Thomas Luthge, Hanau (DE); Ralph McIntosh, Hanau (DE); Klaus Bergemann, Kerpen-Sindorf (DE)

Correspondence Address: FITCH, EVEN, TABIN & FLANNERY, P. O. BOX 65973, WASHINGTON, DC, 20035, US

(21) Appl. No.: 11/105,536

(22) Filed: Apr. 14, 2005

(30) Foreign Application Priority Data
Apr. 17, 2004 (DE) 10 2004 018 746.0

(51) Int. Cl. C09D 11/00

(52) U.S. Cl. 106/472; 106/31.6; 106/473

(57) ABSTRACT

Carbon material with organic groups, obtainable by conversion of carbon material with organic compounds of the general formula 1 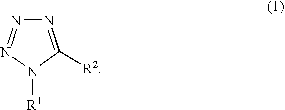 The carbon materials with organic groups according to the invention may be used as fillers, reinforcing fillers, UV stabilisers, conductive carbon blacks or pigment.

### CROSS REFERENCE TO RELATED APPLICATIONS

The present application claims priority to German application 10 2004 018 746.0, filed on Apr. 17, 2004, the content of which is hereby incorporated by reference.

### FIELD OF THE INVENTION

The present invention relates to a carbon material, to a process for its production, and to its use.

### BACKGROUND OF THE INVENTION

A process for the surface modification of carbon materials with aromatic groups by electrochemical reduction of a diazonium salt is known from EP 0 569 503. It is also known to provide carbon materials in which organic groups are linked to the carbon material via a diazotisation process (WO 96/18690) which binds groups using radical-formers (Ohkita, et al., Carbon 16:41 (1978); DE 10012784.3) or via cycloadditions (DE 10012783.5, JP 11315220 A). The known processes have the following disadvantages:
The diazotisation process generally involves the use of either toxic and oxidising sodium nitrite or non-ionic organic nitrites that are toxic and highly flammable. Residues of the nitrites (counter-ions, alkyl residues) remain uncombined in the carbon material in the form of contaminants.
Diazotisation requires the use of nitrite in acidic medium and toxic nitrogen oxides may be formed in the process.
Radical-formers are thermally or photochemically unstable, potentially explosive and may lead to chain reactions that are difficult to control.
The synthesis and purification of precursors of radical-formers proceed, in part, by way of toxic or foul-smelling substances.

### OBJECT OF THE INVENTION

It is an object of the invention to make available a carbon material with organic groups, in which:
the modification of the carbon material is so variable that the groups influencing properties of the carbon material may be disposed close to the surface of the carbon material and/or also far removed from the surface of the carbon material;
the modification of the carbon material takes place without preliminary reactions such as activation by initiators;
the conversions with the modifying agents that are used in accordance with the invention take place thermally, and additional catalysts (for example, Lewis acids) are not needed;
modifying agents do not generate troublesome secondary reactions or chain reactions that are difficult to control;
the resulting carbon material is not contaminated by inorganic acids or salts and the like, so that no purification of the carbon material is required;
the carbon material does not have to be dried with a high expenditure of energy;
no toxic waste gases arise in the course of the modification;
solvents are either entirely absent or present in only small amounts and, in addition, are easily removed;
the use of toxic and oxidising alkali nitrites or toxic and flammable non-ionic organic nitrites is avoided and consequently no residues of the nitrites (counter-ions, alkyl residues) remain uncombined in the carbon material and
no radical-formers are used that may be thermally or photochemically unstable and potentially explosive and may lead to chain reactions that are difficult to control.

### DESCRIPTION OF THE INVENTION

The invention provides a carbon material with organic groups, said material being characterised in that it is obtainable by the conversion of carbon material with organic compounds of the general formula 1, 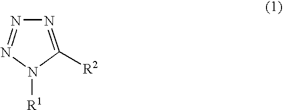
wherein R¹ and R² are the same or different and consist of H, acceptor groups, donor groups, alkyl or aryl groups with acceptor or donor groups and/or hydrophilic or hydrophobic groups, or R¹ and R² form a heterocyclic system which in turn is substituted by acceptor or donor groups and/or hydrophilic or hydrophobic groups.

Acceptor groups may be —COOR³, —CO—R³, —CN, —SO₂R³ or —SO₂OR³, with R³=metal, H, alkyl, aryl, ammonium or functionalised alkyl or aryl, such as, for example, ω-carboxyalkyl, HSO₃—CₓH_{y}—, H₂N—CₓH_{y}— or H₂N—SO₂—CₓH_{y}— (x,y=1-45).

Donor groups may be SR⁴, OR⁴ or N(R⁴)₂, with R⁴═H, alkyl, aryl, or functionalised alkyl or aryl. Hydrophilic groups may be —SO₃M (M=metal), COOM, —(CH₂—CH₂—O)ₙR⁴. Hydrophobic groups may be alkyl, fluoroalkyl, perfluoroalkyl, fluoroaryl, perfluoroaryl.

The organic groups R¹ and R² may:
be substituted or unsubstituted, branched or unbranched,
comprise an aliphatic group, for example residues from alkanes, alkenes, alcohols, ethers, aldehydes, ketones, carboxylic acids, esters, hydrocarbons, sulfonic acids, amines, trialkylammonium salts, trialkylphosphonium salts, dialkylsulfonium salts,
be a cyclic compound, for example alicyclic hydrocarbons such as, for example, cycloalkyls or cycloalkenyls, heterocyclic compounds such as, for example, pyrrolidinyl, pyrrolinyl, piperidinyl or morpholinyl, aryl groups such as, for example, phenyl, naphthyl or anthracenyl, and heteroaryl groups such as, for example, imidazolyl, pyrazolyl, pyridinyl, thienyl, thiazolyl, furyl or indolyl,
the heterocyclic system may contain nitrogen, carbon or further heteroatoms and may form a three-membered, four-membered, five-membered, six-membered or higher-membered ring which in turn is substituted by H, alkyl or aryl groups with acceptor or donor substituents or with parts of cyclic systems with acceptor or donor substituents and/or hydrophilic or hydrophobic groups,
be substituted by further functional groups,
be a chromophoric group or a dyestuff,
be suitable reactive compounds such as, for example, triarylammonium salts, triarylphosphonium salts, diarylsulfonium salts and aryliodonium salts.

The groups of the organic compounds of the general formula 1 may be customised to the potential fields of application, since the reaction principle permits, for example, the introduction both of hydrophilic groups and of lipophilic groups. The groups may also be ionic, polymeric or reactive with respect to further reactions. Via the groups, a variety of properties of the carbon material which are of application-oriented interest may be changed selectively. For instance, the hydrophilicity of the carbon material may be increased so much that the carbon material forms stable dispersions in aqueous media without the use of a wetting agent.

Carbon black, graphite powder, graphite fibres, carbon fibres, carbon fibrils, carbon nanotubes, carbon fabric, vitreous carbon products, activated charcoal or fullerenes may be employed by way of carbon material. Furnace black, gas black, channel black, flame black, thermal black, acetylene black, plasma black, inversion blacks, known from DE 195 21 565, silicon-containing blacks, known from WO 98/45361 or DE 196 13 796, or metal- containing blacks, known from WO 98/42778, arc black and blacks that are by-products of chemical production processes may be employed by way of carbon black. The carbon material may be activated by means of preliminary reactions. Carbon materials that are used as reinforcing filler in rubber mixtures and colour blacks may also be employed. Further carbon materials may be: conductive carbon black, carbon material for UV stabilisation, carbon material as filler in systems other than rubber, such as, for example, in bitumen or synthetic material, or carbon material by way of reducing agent in metallurgy.

The invention further provides a process for producing the carbon material with organic groups as described above. This process is characterised in that carbon material is caused to react with organic compounds of the general formula 1. Specifically, an organic compound of general formula 1 may be applied onto the carbon material by being mixed in or sprayed on. The organic compound may be applied in the form of powder, melt or solution. In a particularly advantageous embodiment, the application of the organic compound is during the production of the carbon material, the addition of the organic compound preferably being undertaken at a position in the reactor that exhibits the requisite temperature. The reaction for the purpose of modifying the carbon material may preferably be carried out in solvent-free manner, but it may also be carried out in a solvent, preferably in a readily volatile organic solvent. The reaction for the purpose of modifying the carbon material may be carried out at temperatures from −80° C. to 300° C., and preferably from 80° C. to 250° C. Energy input may be effected by means of mechanical energy, vibrational energy, for example ultrasound, or radiant energy, for example microwave radiation, thermal radiation, light radiation, X-ray radiation and electron radiation.

The carbon materials with organic groups according to the invention may be employed as filler, reinforcing filler, UV stabiliser, conductive carbon black or pigment in rubber, synthetic material, printing inks, writing inks, inkjet inks, lacquers and paints, bitumen, concrete and other building materials or paper. Furthermore, the carbon materials with organic groups according to the invention may be used as reducing agents in metallurgy.

The invention further provides a dispersion which is characterised in that it contains the carbon material with organic groups according to the invention. In this connection, the organic group may be customised to the respective dispersion medium. Thus carbon materials modified with polar organic groups may be particularly suitable for polar media. Polar media may be solvents such as, for example, alcohols, ketones, esters, acids, amines, glycols, glycol ethers or halogenated solvents, but they may also be oligomers or polymers with polar groups such as, for example, carbonyl, ester, amino, carboxyl and/or hydroxyl groups. Carbon materials with organic groups such as, for example, —SO₃X, COOX or OH, with X for example ═H, alkali ions or ammonium ions, may be particularly well-suited for aqueous media. Hydrophobically modified carbon materials with hydrophobic groups such as alkyl, alkyloxy, aryl and/or hetaryl may be particularly well-suited for hydrophobic media such as aliphatic, aromatic, heteroaliphatic and/or heteroaromatic hydrocarbons. For media that, as regards their polarity, lie between the relatively non-polar, hydrophobic media and the strongly polar media, such as, for example, ethers and/or mixtures of polar and non-polar media, specially matched modifications, for example with amino, carbonyl or halogen substituents, may be particularly well-suited. The dispersion according to the invention may be used in printing inks, writing inks, lacquers and paints.

The carbon materials with organic groups according to the invention have the advantage that:
carbon materials modified in a polar manner (for example with —SO₃M substituents) are more readily dispersible in polar systems, primarily water,
carbon materials modified in a non-polar manner (for example with alkyl groups) are more readily dispersible in non-polar systems such as oils, for example,
suitable modified carbon materials with polar or sterically bulky groups in the systems are electrostatically or sterically stabilised, and no further auxiliary substances, such as wetting agents for example, are necessary for the purpose of stabilisation,
carbon materials modified in accordance with the process according to the invention are more readily stabilised in dispersions and so exhibit better colouristic properties such as depth of colour and bluish tingeing,
carbon materials with bound dyestuffs exhibit changed hues,
carbon materials with further reactive substituents can be utilised for the purpose of coupling and cross-linking in systems (for example, rubber),
reactively modified carbon materials enable a linkage of the carbon materials to a polymer and
carbon materials can thereby be produced having a low content of by-products, salts, acids and moisture.

### EXAMPLES

In the Examples, the carbon blacks Farbruβ FW 1, Farbruβ FW 18 and Printex 95 are employed by way of carbon material. The stated carbon blacks are products of Degussa AG. The dynamic surface tension and the static surface tension are measured with a BP2 bubble tensiometer manufactured by Krüss, the viscosity is measured with a Physica US 200 (double-slit measuring system), and the pH value is measured with a CG 837 pH meter.

### Example 1

Modification of Carbon Material with Sodium-3-(5-mercaptotetrazol-1-yl)benzenesulfonate

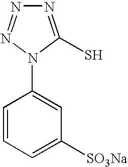

2 g sodium-3-(5-mercaptotetrazol-1-yl)benzenesulfonate are dissolved in 150 ml water, 10 g carbon black FW 18 are added, then the solvent is distilled off in a vacuum, and the residual mixture is heated for 3 hours to 200° C. The modified carbon black is washed with 150 ml water and then dried at room temperature.

### Example 2

Modification of Carbon Material in Solid Phase with Sodium-3-(5-mercaptotetrazol-1-yl)benzenesulfonate

2 g sodium-3-(5-mercaptotetrazol-1-yl)benzenesulfonate and 10 g carbon black FW 18 are mixed and subsequently heated for 4 hours to 200° C.

### Example 3

Modification of Carbon Material in Solid Phase with Sodium-3-(5-benzylthiotetrazol-1-yl)benzenesulfonate

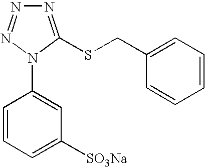

2 g sodium-3-(5-benzylthiotetrazol-1-yl)benzenesulfonate are dissolved in 150 ml water, 10 g carbon black FW 18 are added, then the solvent is distilled off in a vacuum, and the residual mixture is heated for 3 hours to 200° C. The modified carbon black is washed with 150 ml water and then dried at room temperature.

### Example 4

Modification of Carbon Material with Sodium-3-(5-sodium sulfonatobutylthiotetrazol-1-yl)benzenesulfonate

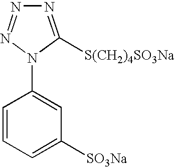

2 g sodium-3-(5-sodium sulfonatobutylthiotetrazol-1-yl)benzenesulfonate are dissolved in 150 ml water, 10 g carbon black FW 18 are added, then the solvent is distilled off in a vacuum, and the residual mixture is heated for 3 hours to 200° C. The modified carbon black is washed with 150 ml water and then dried at room temperature.

### Example 5

Modification of Carbon Material with 1-(4-dodecyloxyphenyl)-5-dodecylthiotetrazole

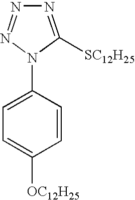

2 g 1-(4-dodecyloxyphenyl)-5-dodecylthiotetrazole are dissolved in 150 ml acetone, 10 g carbon black FW 1 are added, then the solvent is distilled off in a vacuum, and the residual mixture is heated for 3 hours to 200° C. The modified carbon black is washed with 150 ml acetone and then dried at room temperature.

### Example 6

Modification of Carbon Material with 3-(5-benzylthiotetrazol-1-yl)benzenesulfonamide

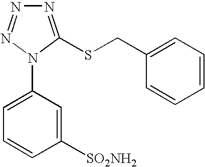

2 g 3-(5-benzylthiotetrazol-1-yl)benzenesulfonamide are dissolved in 150 ml acetone, 10 g carbon black Printex 95 are added, then the solvent is distilled off in a vacuum, and the residual mixture is heated for 3 hours to 200° C. The modified carbon black is washed with 150 ml acetone and then dried at room temperature.

### Example 7

Dispersion of Modified Carbon Material in Water

15 g carbon material with organic groups according to Example 1 are mixed together with 85 ml water and are subsequently dispersed for 30 minutes at 5000 rpm by means of an Ultra Turrax. The dispersion obtained is stable without further addition of wetting agent.

Dynamic surface tension at 15 ms: 62 mN/m. Static surface tension at 3000 ms: 59 mN/m pH value: 7.5 Viscosity: 2.33 mPas

### Example 8

Dispersion of Modified Carbon Material in Water

15 g carbon material with organic groups according to Example 2 are mixed together with 85 ml water and are subsequently dispersed for 30 minutes at 5000 rpm by means of an Ultra Turrax. The dispersion obtained is stable without further addition of wetting agent.

Dynamic surface tension at 15 ms: 65 mN/m. Static surface tension at 3000 ms: 60 mN/m, pH value: 7.8 Viscosity: 2.17 mPas

### Example 9

Dispersion of Modified Carbon Material in Water

15 g carbon material with organic groups according to Example 3 are mixed together with 85 ml water and are subsequently dispersed for 30 minutes at 5000 rpm by means of an Ultra Turrax. The dispersion obtained is stable without further addition of wetting agent

Dynamic surface tension at 15 ms: 72 mN/m. Static surface tension at 3000 ms: 65 mN/m, pH value: 82, Viscosity: 2.29 mPas.

### Example 10

Dispersion of Modified Carbon Material in Water

15 g carbon material with organic groups according to Example 4 are mixed together with 85 ml water and are subsequently dispersed for 30 minutes at 5000 rpm by means of an Ultra Turrax. The dispersion obtained is stable without further addition of wetting agent. Dynamic surface tension at 15 ms: 71 mN/m. Static surface tension at 3000 ms: 63 mN/m pH value: 8.0 Viscosity: 2.04 mPas.

All references cited herein are fully incorporated by reference. Having now fully described the invention, it will be understood by those of skill in the art that the invention may be practiced within a wide and equivalent range of conditions, parameters and the like, without affecting the spirit or scope of the invention or any embodiment thereof.

1. Carbon material with organic groups, produced by the process of reacting carbon material with organic compounds of the general formula 1, 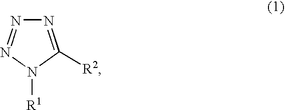
wherein R¹ and R² are the same or different and consist of H, acceptor groups, donor groups, alkyl or aryl groups with acceptor or donor substituents and/or hydrophilic or hydrophobic groups, or R¹ and R² form a heterocyclic system which in turn is substituted by acceptor or donor groups and/or hydrophilic or hydrophobic groups.

2. Carbon material with organic groups according to claim 1, wherein said carbon material is carbon black, graphite powder, graphite fibres, carbon fibres, carbon fibrils, carbon nanotubes, carbon fabric, vitreous carbon products, activated charcoal or fullerenes.

3. Carbon material with organic groups according to claim 1, characterised in that the acceptor groups are —COOR³, —CO—R³, —CN, —SO₂R³ or —SO₂OR³, wherein R³=metal, H, alkyl, aryl, ammonium or functionalised alkyl or aryl.

4. Carbon material with organic groups according to claim 1, characterised in that the donor groups are alkyl, aryl, SR⁴, OR⁴ or N(R⁴)₂, wherein R⁴═H, alkyl, aryl, or functionalised alkyl or aryl.

5. A process for producing the carbon material with organic groups according to claim 1, wherein in that carbon material is caused to react with organic compounds of the general formula 1.

6. Filler, reinforcing filler, UV stabiliser, conductive carbon black or pigment in rubber, synthetic material, printing inks, writing inks, inkjet inks, lacquers and paints, bitumen, concrete and other building materials or paper comprising the carbon material according to claim 1.

7. A dispersion comprising the carbon material with organic groups according to claim 1.

8. Printing inks, writing inks, lacquers or paints comprising the dispersion of claim 7.
